(19) United States
(12) Patent Application Publication
(10) Pub. No.: US 2010/0007360 A1
(43) Pub. Date: Jan. 14, 2010

(54) FLUID SENSOR DEVICE

(76) Inventors: Udo Kaess, Stuttgart (DE); Monlka Scherer, Reutlingen (DE); Gustav Klett, Moessingen (DE); Markus Niemann, Beckingen (DE)

Correspondence Address: MICHAEL J. STRIKER, 103 EAST NECK ROAD, HUNTINGTON, NY, 11743, US

(21) Appl. No.: 12/443,848

(22) PCT Filed: May 26, 2008
(86) PCT No.: PCT/EP08/56392

§ 371 Date: Apr. 1, 2009

(30) Foreign Application Priority Data
Jun. 6, 2007 (DE) 10 2007 026 449.8

(51) Int. Cl. G01N 27/22

(52) U.S. Cl. 324/672

(57) ABSTRACT

The invention provides a fluid sensor device (1; 1′; 1′; 1″) for detecting a dielectricity constant of a fluid (30) present in a fluid line (20), comprising a housing (5; 5′; 5′; 5″); a plate capacitor device provided on the inside of the housing (5; 5′; 5′; 5″), the plate capacitor device comprising a first and a second capacitor plate (8a, 8b; 8a′, 8b′; 8a′, 8b′; 8a″, 8b″); wherein the housing (5; 5′; 5′; 5″) on the surface thereof has an arched attachment region for attaching the fluid line (20); and wherein the first and second capacitor plates (8a, 8b; 8a′, 8b′; 8a′, 8b′; 8a″, 8b″) are disposed next to the attachment region such that a fluid (30) present in the fluid line (20) attached in the attachment region is provided at least partially between the first and second capacitor plates (8a, 8b; 8a′, 8b′; 8a′, 8b′; 8a″, 8b″).

### PRIOR ART

The present invention relates to a fluid sensor device for measuring a dielectric constant of a fluid in a fluid line.

Although the present invention and the fundamental approach to attaining its object can be applied to any of a number of fluid sensor devices, they will be explained here in the context of an automotive application.

There is a general, growing need for online monitoring of the fluids used in automobiles. In the case of engine oil or hydraulic fluid, such a monitoring makes it possible to optimize fluid changes. With fluids such as vehicle fuels, the monitoring primarily serves to determine the composition or quality of the fuel as precisely as possible in order to optimize engine management for the sake of improved emissions levels, improved engine performance, etc.

Up to now, the use of ethanol and methanol as fuels or fuel additives for autoignition engines has been widely used only in Brazil. The worsening fuel shortage, the rise in fuel prices, the potential for dependence on oil-exporting nations, the need to use renewable resources, and performance advantages combine to make the mixing of ethanol and methanol with petroleum-based fuels an attractive idea for the USA. The ethanol or methanol content in fuel can be estimated in the engine control unit through evaluation of existing signals (for example lambda sensor, air-mass meter, . . . ) (software solution). For certain borderline cases, e.g. a saddle tank, it may be no longer possible to achieve the desired precision by means of the software solution. It is also conceivable that the software solution will no longer be sufficient to comply with future customer demands or legal requirements or that stricter requirements may be placed on the existing sensor signals, which in turn can lead to a significantly higher system cost.

The prior fluid sensors known, for example, from DE 40 34 471 C1 or U.S. Pat. No. 4,915,084, which have a capacitive structure for measuring the dielectric constants of fluids are unsuitable for use in series production since they are much too expensive on the one hand and on the other hand, must be inserted into the fluid.

FR 2 800 872 A1 has disclosed a sensor for measuring the dielectric constant of a fluid. In this known sensor, metal electrodes of a plate capacitor device are attached to the top surface of an insulated fluid line and connected to a corresponding evaluation circuit. An embodiment of this kind is likewise unsuitable for use in the automotive sector because the electrodes are unprotected.

### ADVANTAGES OF THE INVENTION

The fluid sensor device according to the invention defined in claim 1 has the advantage over conventional embodiments that it is simply designed, easy to install, and can be retrofitted with no trouble.

Inside the housing of the fluid sensor device according to the invention, two capacitor plates are mounted at least partially opposite each other under a curved mounting region for the fluid line in such a way that a fluid in the fluid line to which it is mounted is at least partially situated between the first and second capacitor plates. The housing, which is preferably embodied in the form of a shaped plastic part, provides a stable arrangement of the capacitor plates and protects the capacitor plates from aggressive environmental influences. The housing is preferably connected to the fluid line either by clamping the fluid line to a trough of the housing or by routing the fluid line through a passage in the housing. The capacitor plates are mounted inside the housing, along the curved region of the trough or passage. The fluid sensor device according to the invention has no influence at all on the flow of the fluid in the fluid line.

A fluid sensor device of this kind makes it possible, for example, to measure the permittivity in order to determine the ethanol or methanol content in gasoline or to determine the biodiesel content in diesel fuel. Preferably, the evaluation circuit is likewise accommodated in the housing and is able to carry out the evaluation and processing of signals in an integrated evaluation circuit and also to carry out a temperature measurement and a temperature correction as needed of the measured dielectric constant of the fluid. When used in the automotive field, it is easily possible to retrofit all current vehicle types.

The defining characteristics disclosed in the dependent claims relate to advantageous modifications and improvements of the subject of the invention.

According to a preferred modification, the mounting region is the surface region of the housing in a passage extending through the housing. If the fluid line can be clamped into the passage, it is then possible to eliminate an additional attachment of the fluid line.

According to another preferred modification, the mounting region is the surface region of the housing in a trough on the surface of the housing. In this case, a bracket can preferably be fastened to the housing in relation to the trough in such a way that the fluid line can be mounted onto the housing between the trough and the bracket. This permits a simple retrofitting without requiring removal of the fluid line.

According to another preferred modification, the first and second capacitor plates are embodied as flat and are arranged essentially tangential to a curvature line of the mounting region.

According to another preferred modification, the first and second capacitor plates are embodied as curved and are arranged essentially parallel to a curvature line of the mounting region.

According to another preferred modification, the housing is embodied essentially in the form of a hollow cylinder and the passage extends essentially parallel to the axis of the cylinder.

According to another preferred modification, the housing is embodied essentially in the form of a semicylindrical shell and the trough extends essentially parallel to the axis of the cylinder.

According to another preferred modification, the housing is composed of two semicylindrical shells that can swing open to enable mounting of the fluid line.

### DRAWINGS

Exemplary embodiments of the invention are shown in the drawings and will be explained in detail in the description that follows.

FIGS. 1a & b are schematic sectional depictions of a fluid sensor device according to a first embodiment of the present invention; FIG. 1a is a longitudinal section and FIG. 1b is a cross section;

FIG. 2 shows a schematic cross section through a fluid sensor device according to a second embodiment of the present invention;

FIG. 3 shows a schematic cross section through a fluid sensor device according to a third embodiment of the present invention; and

FIG. 4 shows a schematic cross section through a fluid sensor device according to a fourth embodiment of the present invention.

### DESCRIPTION OF EXEMPLARY EMBODIMENTS

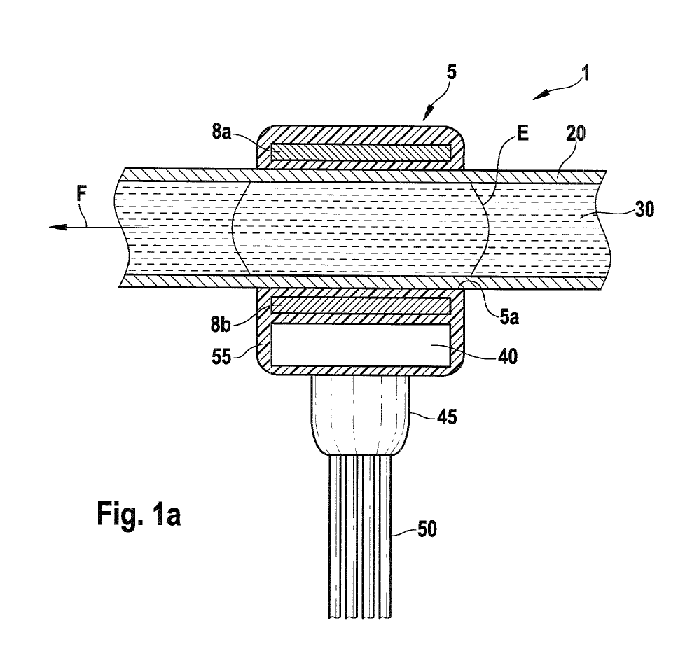

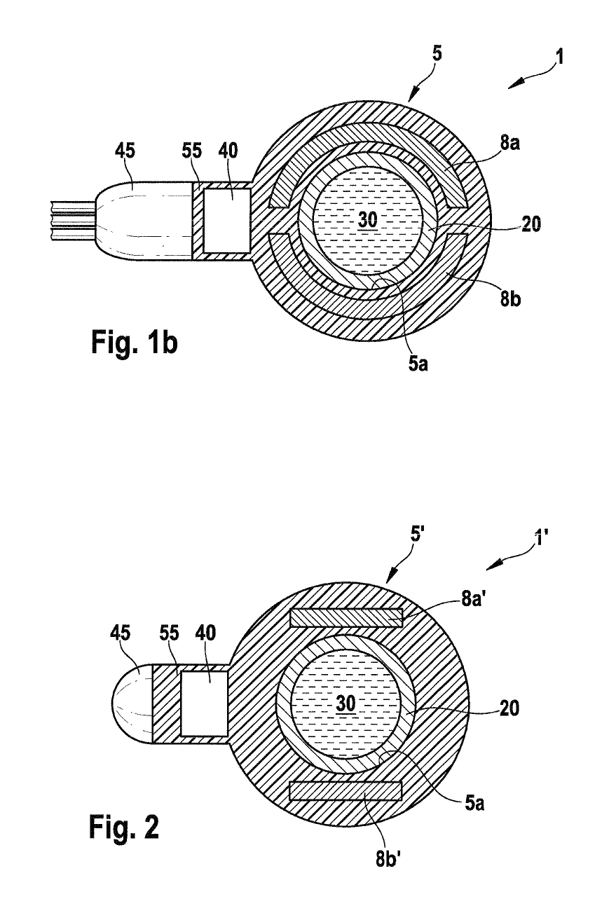

FIGS. 1a & b are schematic sectional depictions of a fluid sensor device according to a first embodiment of the present invention; FIG. 1a is a longitudinal section and FIG. 1b is a cross section.

In FIG. 1a, the reference numeral 20 indicates a fuel line of a motor vehicle and the reference numeral 30 indicates a fuel, e.g. a mixture of gasoline and ethanol flowing in the flow direction F therein.

The fluid sensor device 1 according to this first embodiment has a plate capacitor device, which is provided inside a housing 5 and has a first and second capacitor plate 8a, 8b. The housing 5 is a shaped plastic part embodied in the form of a hollow cylinder with a passage 5a that extends essentially parallel to the axis of the cylinder. The fuel line is routed through the passage 5a, resting flush against the housing wall. When an external voltage is applied to them, the two opposing capacitor plates 8a, 8b produce an electrical field E that passes through the fuel 30. For example, the ethanol content of the fuel 30 can be determined with the aid of the permittivity (possibly taking into account the temperature) of the mixture of fuel and ethanol. The dielectric constant of gasoline is approximately ε=2.0-2.1 while that of ethanol is ε=23.5. The signals are evaluated in an evaluation circuit 40 likewise accommodated in the housing 5, encased in an extension 55 of the housing 5. An electrical plug connector 45, which supplies the signals of the evaluation circuit 40 signal lines 50, can be mounted onto the end of the extension 55.

As is clear from FIG. 1b, the first and second capacitor plates 8a, 8b are embodied as curved and are arranged in the passage 5a, essentially parallel to a curvature line of the wall region of the housing (mounting region for the fluid line).

The fluid sensor device according to the first embodiment is therefore very compact, protects the evaluation electronics from adverse environmental influences, does not influence the flow of the fuel 30, and can be easily mounted by routing the fuel line 20 through it, which requires removal of the fuel line.

Although not shown in FIGS. 1a and 1b, stoppers can be mounted onto the fuel line 20 on both sides of the fluid sensor device in order to prevent the fluid sensor device 1 from slipping on the fuel line 20. This is not as a rule necessary, however, if the fuel line 20 is inserted into the passage 5a under a slight amount of pressure. In addition, a slight degree of slippage could be tolerable since the location of the fluid sensor device on the fuel line plays no part in the measurement of the dielectric constant of the fuel.

FIG. 2 is a schematic cross section through a fluid sensor device according to a second embodiment of the present invention.

The fluid sensor device 1′ according to the second embodiment differs from the fluid sensor device 1 according to the first embodiment described above merely in the shape of the first and second capacitor plates 8a′, 8b′, which are mounted or formed into the housing 5′. The capacitor plates 8a′, 8b′ are embodied as flat and are arranged essentially tangential to a curvature line of the passage 5a.

In both the first and second embodiments, the fluid 30 in the form of the fuel is situated entirely between the first and second capacitor plates 8a, 8b and 8a′, 8b′, respectively.

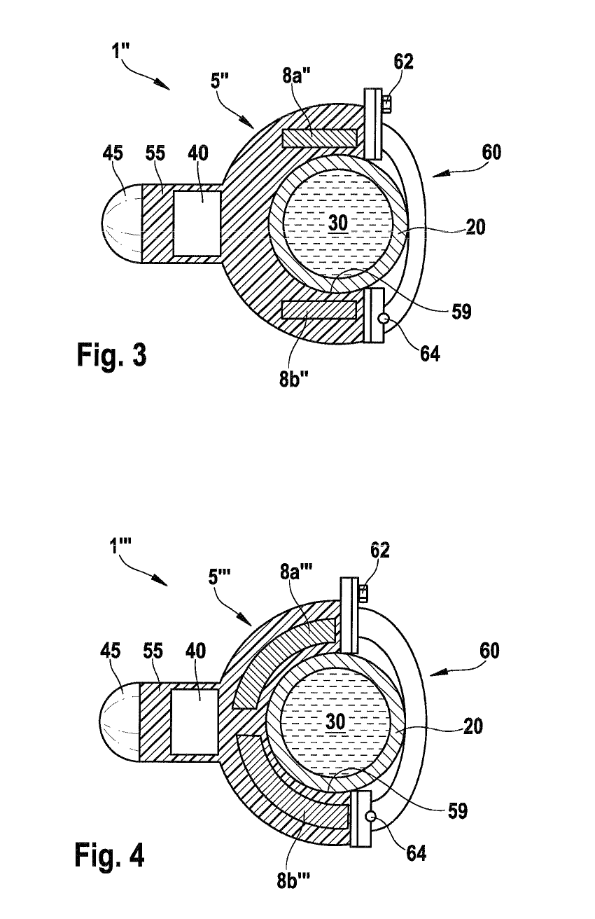

FIG. 3 is a schematic cross section through a fluid sensor device according to a third embodiment of the present invention.

By contrast with the fluid sensor devices according to the first and second embodiments, the fluid sensor device 1″ according to the third embodiment has a different embodiment of the housing 5″. The housing 5″ is likewise embodied as a shaped plastic part; it is not embodied in the form of a hollow cylinder, however, but in the form of a semicylindrical shell in which a trough 59 is provided, in which the fuel line 20 is mounted. The fuel line 20 is mounted by means of a metallic clamping bracket 60 that is fastened to the plastic housing 5″. The clamping bracket 60 has a hinge 64 at its first end and a detachable fastening device 62 at its second end. The detachable fastening device 62 can, for example, be a screw or a clamp. When the clamping bracket 60 is closed, the fuel line 20 rests flush against the trough. In order to mount the fuel line 20, the clamping bracket 60 is opened, then the fuel line 20 is inserted, and finally, the clamping bracket 60 is closed again. This mounting method therefore does not require a removal of the fuel line 20 in order to route it through the bracket.

As in the second embodiment, the capacitor plates 8a″, 8b″ are situated inside the housing 5″ and likewise extend tangential to the curvature line of the trough. In this embodiment, however, the entire cross section of the fuel 30 is not situated between the capacitor plates 8a″, 8b″, but instead only two thirds of the cross section is. This is due to the semicylindrical form of the housing, but does not have a negative impact on the quality of the measurement signal.

The extension 55 with the integrated evaluation circuit 40 and the plug connector 45 mounted onto it corresponds to those in the embodiments described above.

FIG. 4 shows a schematic cross section through a fluid sensor device according to a fourth embodiment of the present invention.

The fluid sensor device 1′″ according to the fourth embodiment likewise has a semicylindrical housing 5′″. The only difference from the third embodiment lies in the fact that the capacitor plates 8a′″, 8b′″ are embodied as curved and are mounted essentially tangential to a curvature line of the trough 59. In addition, the capacitor plates 8a′″, 8b′″ in this fourth exemplary embodiment are not arranged with both ends opposite one another, but are instead slightly rotated in relation to each other. They thus form a plate capacitor whose plate distance changes from one end to the other. Such an arrangement of the capacitor plates 8a′″, 8b′″, however, likewise permits a proper signal quality.

Although the present invention has been explained above in conjunction with a preferred exemplary embodiment, it is not limited to this embodiment, but can also be used in other ways.

It is also possible, for example, for the housing to be composed of two semicylindrical shells that can swing open by means of a hinge to enable mounting of the fluid line.

Naturally, in addition to the semicylindrical embodiment of the housing or the hollow, cylindrical embodiment of the housing, there are also many other conceivable housing shapes with curved mounting regions for the fluid line. In addition, the arrangement of the capacitor plates inside the housing next to or under the mounting region for the fluid line can be varied within a broad range of possibilities. It is likewise conceivable to use more than just two capacitor plates.

Although the embodiments described above all relate to the use in the automotive field for measuring the dielectric constant of the fuel in the fuel line, the present invention is not limited to this, but can instead be used for any fluid contained in any fluid line.

What is claimed is:

1. A fluid sensor device (1; 1′; 1″; 1′″) for measuring a dielectric constant of a fluid (30) in a fluid line (20), having:
a housing (5; 5′; 5″; 5′″);
a plate capacitor device with a first and second capacitor plate (8a, 8b; 8a′, 8b′; 8a″, 8b″; 8c′″, 8c′″) provided inside the housing (5; 5′; 5″; 5′″);
wherein the surface of the housing (5; 5′; 5″; 5′″) has a curved mounting region for mounting the fluid line (20); and
the first and second capacitor plates (8a, 8b; 8a′, 8b′; 8a″, 8b″; 8c′″, 8c′″) are situated next to the mounting region in such a way that a fluid (30) in the fluid line (20) mounted in the mounting region is at least partially situated between the first and second capacitor plates (8a, 8b; 8a′, 8b′; 8a″, 8b″; 8c′″, 8c′″).

2. The fluid sensor device as recited in claim 1,
wherein the mounting region is the surface region of the housing (5; 5′; 5″; 5′″) in a passage extending through the housing (5; 5′; 5″; 5′″).

3. The fluid sensor device as recited in claim 1,
wherein the mounting region is the surface region of the housing (5; 5′; 5″; 5′″) in a trough (59) on the surface of the housing (5; 5′; 5″; 5′″).

4. The fluid sensor device as recited in claim 3,
wherein it is possible for a bracket (60) to be fastened to the housing in relation to the trough (59) in such a way that it is possible to mount the fluid line (20) onto the housing (5; 5′; 5″; 5′″) between the trough (59) and the bracket (60).

5. The fluid sensor device as recited in claim 4,
wherein the clamping bracket (60) has a hinge (64) at its first end and a detachable fastening device (62) at its second end.

6. The fluid sensor device as recited in claim 4, wherein the bracket (60) is a metallic clamping bracket.

7. The fluid sensor device as recited in claim 1,
wherein the first and second capacitor plates (8a, 8b; 8a′, 8b′; 8a″, 8b″; 8c′″, 8c′″) are embodied as flat and are arranged essentially tangential to a curvature line of the mounting region.

8. The fluid sensor device as recited in one of the preceding claim 1,
wherein the first and second capacitor plates (8a, 8b; 8a′, 8b′; 8a″, 8b″; 8c′″, 8c′″) are embodied as curved and are arranged essentially parallel to a curvature line of the mounting region.

9. The fluid sensor device as recited in claim 2,
wherein the housing (5; 5′; 5″; 5′″) is embodied essentially in the form of a hollow cylinder and the passage (5a) extends essentially parallel to the axis of the cylinder.

10. The fluid sensor device as recited in claim 3,
wherein the housing (5; 5′; 5″; 5′″) is embodied essentially in the form of a semicylindrical shell and the trough (59) extends essentially parallel to the axis of the cylinder.

11. The fluid sensor device as recited in one of the preceding claim 1,
wherein the housing (5; 5′; 5″; 5′″) has an extension (55) in which an evaluation device (40) connected to the plate capacitor device is at least partially accommodated.

12. The fluid sensor device as recited in claim 11,
wherein it is possible for an electrical plug connector device (45) to be mounted onto the end of the extension (55).

13. The fluid sensor device as recited in claim 1,
wherein the housing (5; 5′; 5″; 5′″) is a shaped plastic part.

14. The fluid sensor device as recited in claim 2, wherein the housing (5; 5′; 5″; 5′″) is composed of two semicylindrical shells that are able to swing open to enable mounting of the fluid line (20).

15. A use of a fluid sensor device as recited in claim 1 for measuring a dielectric constant of a fuel (30) in a fuel line (20) of a motor vehicle.
